(19) United States
(12) Patent Application Publication
(10) Pub. No.: US 2024/0385875 A1
(43) Pub. Date: Nov. 21, 2024

(54) METHOD THAT IS PERFORMED BY IN-VEHICLE DEVICE AND STORAGE MEDIUM

(71) Applicant: TOYOTA JIDOSHA KABUSHIKI KAISHA, Toyota-shi (JP)

(72) Inventor: Kunihiro MURAKAMI, Okazaki-shi (JP)

(73) Assignee: TOYOTA JIDOSHA KABUSHIKI KAISHA, Toyota-shi (JP)

(21) Appl. No.: 18/442,310

(22) Filed: Feb. 15, 2024

(30) Foreign Application Priority Data
May 19, 2023 (JP) 2023-083457

(51) Int. Cl. G06F 9/48

(52) U.S. Cl. CPC G06F 9/4881

(57) ABSTRACT

The in-vehicle device adds the first task that has occurred to the end of the queue. The in-vehicle device performs a switching process including a step of determining whether there is an unexecuted second task immediately before the first task in the queue, a step of comparing the first priority assigned to the first task with the second priority assigned to the second task when it is determined that the second task exists, and a step of switching the order of the first task and the second task in the queue when it is determined that the first priority is higher than the second priority. The in-vehicle device repeatedly performs the switching process until it is determined that there is no unexecuted second task immediately before the first task in the queue, or until it is determined that the first priority is equal to or lower than the second priority.

### CROSS-REFERENCE TO RELATED APPLICATION

This application claims priority to Japanese Patent Application No. 2023-083457 filed on May 19, 2023, incorporated herein by reference in its entirety.

### BACKGROUND

### 1. Technical Field

The present disclosure relates to methods that are performed by an in-vehicle device and a storage medium.

### 2. Description of Related Art

Conventionally, functions such as a remote control function of a vehicle are performed by a dedicated microcontroller out of a plurality of microcontrollers mounted on the vehicle. For example, Japanese Unexamined Patent Application Publication No. 2020-125050 (JP 2020-125050 A) discloses that a vehicle starts a pre-air-conditioning operation in response to an operation performed on a remote control device.

### SUMMARY

In next-generation vehicles such as motor vehicles using electric power as a power source, part of functions of the vehicle, such as a remote control function, is managed collectively by an operating system (OS) of an in-vehicle device without using a dedicated microcontroller. In this case, there is room for improvement in the technology of in-vehicle devices for vehicles.

An object of the present disclosure made in view of such circumstances is to improve the technology of in-vehicle devices for the next-generation vehicles.

A method according to an embodiment of the present disclosure is a method that is performed by an in-vehicle device configured to add a plurality of tasks to a queue in order of occurrence. The method includes:
adding a first task that has occurred to an end of the queue; and
performing a switching process, the switching process including the steps of determining whether there is an unexecuted second task immediately before the first task in the queue,
when determination is made that there is the unexecuted second task, comparing a first priority assigned to the first task with a second priority assigned to the second task, and
when determination is made that the first priority is higher than the second priority, switching an order of the first task and the second task in the queue.
   The in-vehicle device repeatedly performs the switching process until determination is made that there is no unexecuted second task immediately before the first task in the queue, or until determination is made that the first priority is equal to or lower than the second priority of the unexecuted second task immediately before the first task in the queue.

A storage medium storing a program according to an embodiment of the present disclosure is a storage medium storing a program that causes an in-vehicle device configured to add a plurality of tasks to a queue in order of occurrence to add a first task that has occurred to an end of the queue, and perform a switching process, the switching process including the steps of determining whether there is an unexecuted second task immediately before the first task in the queue, when determination is made that there is the unexecuted second task, comparing a first priority assigned to the first task with a second priority assigned to the second task, and when determination is made that the first priority is higher than the second priority, switching an order of the first task and the second task in the queue.

The in-vehicle device is caused to repeatedly perform the switching process until determination is made that there is no unexecuted second task immediately before the first task in the queue, or until determination is made that the first priority is equal to or lower than the second priority of the unexecuted second task immediately before the first task in the queue.

According to an embodiment of the present disclosure, the technology of in-vehicle devices for next-generation vehicles is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of hardware of an in-vehicle device;

FIG. 3 is a block diagram illustrating a schematic configuration of software of an in-vehicle device;

FIG. 4 is a flow chart showing the operation of the in-vehicle device; and

FIG. 5 is a conceptual diagram showing a state of a queue of an in-vehicle device in a case where the present embodiment is not provided and a state of a queue of an in-vehicle device in a case where the present embodiment is provided.

### DETAILED DESCRIPTION OF EMBODIMENTS

Hereinafter, an embodiment of the present disclosure will be described.

### Outline of Embodiment

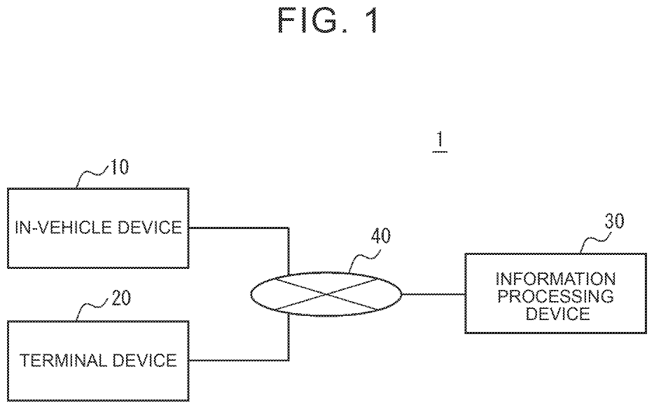

The outline of a system 1 according to an embodiment of the present disclosure will be described with reference to FIG. 1. The system 1 includes an in-vehicle device 10, a terminal device 20, and an information processing device 30. The in-vehicle device 10, the terminal device 20, and the information processing device 30 are communicably connected to a network 40 including, for example, the Internet and a mobile communication network.

The in-vehicle device 10 is a computer mounted on a vehicle. The computer is equipped with a OS. As will be described later, OS adds a plurality of tasks to the queue in order of occurrence. The vehicle is, for example, an automobile, but is not limited thereto, and may be any vehicle. Vehicles are motor vehicles powered by electrical power, such as, but not limited to, Battery Electric Vehicle (BEV), Hybrid Electric Vehicle (HEV), Plug-in Hybrid Electric Vehicle (PHEV), or Fuel Cell Electric Vehicle).

The terminal device 20 is, for example, a Personal Computer (PC), a computer such as a smart phone or a bullet terminal, or a dedicated device having a function as a key of the vehicle, and is a vehicle portable device such as a key phone, a smart key, a key card, or the like. In the present embodiment, the terminal device 20 is capable of communicating with the in-vehicle device 10, and is used by a user such as a driver of a vehicle, for example, to remotely control the vehicle.

The information processing device 30 is, for example, a computer such as a server device. The information processing device 30 can communicate with the in-vehicle device 10 and the terminal device 20 via the network 40.

First, the outline of the present embodiment will be described, and the details will be described later. The in-vehicle device 10 adds the first task that has occurred to the end of the queue. Next, the in-vehicle device 10 performs a switching process including a step of determining whether there is an unexecuted second task immediately before the first task in the queue, a step of comparing the first priority assigned to the first task with the second priority assigned to the second task when it is determined that there is the second task, and a step of switching the order of the first task and the second task in the queue when it is determined that the first priority is higher than the second priority. The in-vehicle device 10 repeatedly performs the switching process until it is determined that there is no unexecuted second task immediately before the first task in the queue, or until it is determined that the first priority is equal to or lower than the second priority of the unexecuted second task immediately before the first task in the queue.

As described above, according to the present embodiment, since the first task is executed earlier than the unexecuted task having a lower priority than the first task, the response of the function performed by the execution of the first task may be faster than that of the in-vehicle device without the present embodiment. Therefore, according to the present embodiment, the technology of the in-vehicle devices for the next-generation vehicles is improved in that the response of the function having a high priority can be improved.

Next, each configuration of the system 1 will be described in detail.

### Hardware Configuration of The In-Vehicle Device

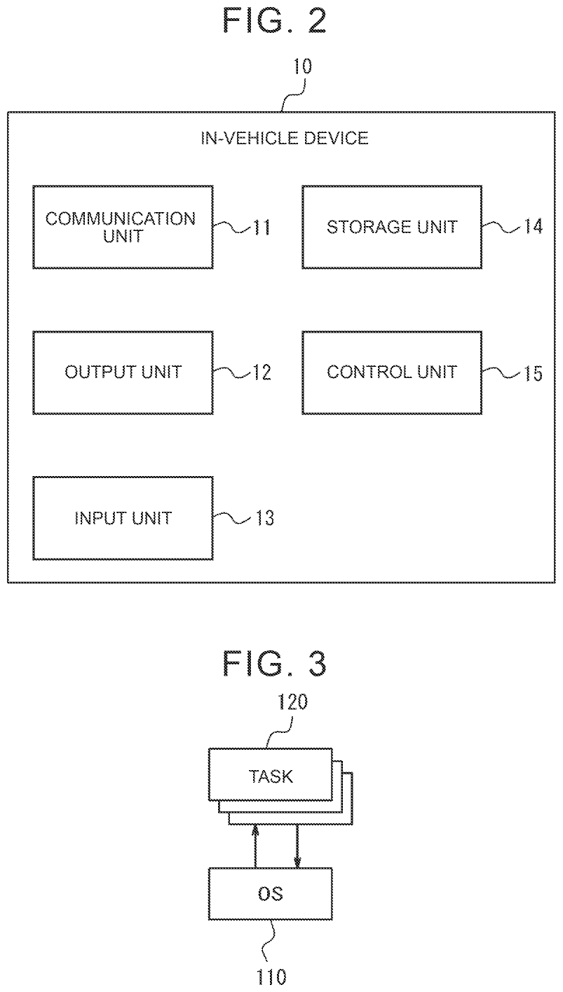

As illustrated in FIG. 2, the in-vehicle device 10 includes a communication unit 11, an output unit 12, an input unit 13, a storage unit 14, and a control unit 15.

The communication unit 11 includes one or more communication interfaces connected to the network 40. The communication interface corresponds to a mobile communication standard such as 4th Generation (4G) or 5th Generation (5G), but the communication interface is not limited thereto. In the present embodiment, the in-vehicle device 10 communicates with the terminal device 20 and the information processing device 30 via the communication unit 11 and the network 40.

The output unit 12 includes one or more output devices for outputting information. The output device is, for example, a display for outputting information by video, a speaker for outputting information by sound, or the like, but the output device is not limited thereto. Alternatively, the output unit 12 may include an interface for connecting an external output device.

The input unit 13 includes one or more input devices that detect an input operation by a user. The input device is, for example, a physical key, a capacitive key, a mouse, a touch panel, a touch screen integrally provided with a display of the output unit 12, a microphone, or the like, but the input device is not limited thereto. Alternatively, the input unit 13 may include an interface for connecting an external input device.

The storage unit 14 includes one or more memories (storage media). The memory is, for example, a semiconductor memory, a magnetic memory, an optical memory, or the like, but the memory is not limited thereto. Each memory included in the storage unit 14 may function as, for example, a main storage device, an auxiliary storage device, or a cache memory. For example, the storage unit 14 may store a system program, an application program, and embedded software. For example, the information stored in the storage unit 14 may be updatable by, for example, information acquired from the network 40 via the communication unit 11.

The control unit 15 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuit is, for example, Application Specific Integrated Circuit (ASIC), but the dedicated circuit is not limited thereto. The control unit 15 controls the operation of the entire vehicle including the in-vehicle device 10.

### Software Configuration of The In-Vehicle Device

As shown in FIG. 3, the in-vehicle device 10 includes a OS 110 and a cue to which a task 120 that has occurred is added.

OS 110 manages the performance of the plurality of tasks 120. OS 110 include, for example, OS such as Microsoft Windows (registered trademark), UNIX (registered trademark), Solaris (registered trademark), LINUX (registered trademark), Apple (registered trademark), MAC-OS (registered trademark), Apple iOS (registered trademark), and the like. Each time one of the plurality of tasks 120 occurs, OS 110 adds it to the end of the queue to manage the order in which each of the plurality of tasks 120 is executed.

In the present embodiment, each of the plurality of tasks 120 is a task that occurs in response to a user operation on the terminal device 20 or a task other than the task. Specifically, the task that occurs in response to a user operation on the terminal device 20 is a task that occurs in response to a so-called remote operation, such as a task of remotely opening and closing a door of the vehicle or a task of remotely operating an air conditioner of the vehicle, but the task that occurs in response to a user operation on the terminal device 20 is not limited to these tasks. Further, the other tasks are, for example, a task for executing a data collection function for sending a state of a vehicle or the like to the information processing device 30 or a task for setting a vehicle, but the tasks are not limited to these tasks.

### Operation Flow of In-Vehicle Device

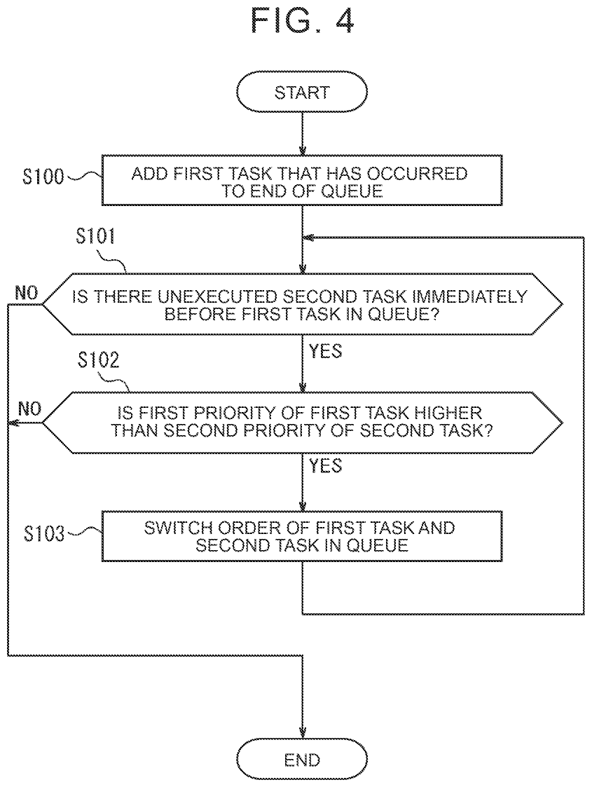

Next, an operation of the in-vehicle device 10 according to the present embodiment will be described with reference to FIG. 4.

S100: The control unit 15 of the in-vehicle device 10 adds the first task that has occurred to the end of the queue.

The first task occurs in response to, for example, a user operation using the terminal device 20, a data transmission request such as a condition of a vehicle from the information processing device 30, a request from the outside of the in-vehicle device 10 such as data reception at regular intervals, a timer activation, or the like, but is not limited thereto. The first task occurs in response to any trigger. The control unit 15 adds the first task that has occurred to the end of the queue stored in the storage unit 14.

S101: The control unit 15 determines whether there is an unexecuted second task immediately before the first task in the queue. When it is determined that there is an unexecuted second task (S101—Yes), the process proceeds to S102, and when it is determined that there is no unexecuted second task (S101—No), the process ends.

Specifically, the control unit 15 checks whether the second task is present immediately before the first task in the queue stored in the storage unit 14. When it is determined that the second task is present immediately before the first task, the control unit 15 next checks the status of the second task. If it is determined that the status is not yet executed (S101—Yes), the processing proceeds to S102. On the other hand, when it is determined that the second task is not present immediately before the first task, or if it is determined that the second task is present but the status is not “unexecuted” (S101—No), the processing ends.

S102: When it is determined that there is an unexecuted second task in S101 (S101—Yes), the control unit 15 compares the first priority assigned to the first task with the second priority assigned to the second task. When it is determined that the first priority is higher than the second priority (S102—Yes), the process proceeds to S103, and when it is determined that there is no priority (S102—No), the process ends.

Specifically, when it is determined that there is an unexecuted second task in S101 (S101—Yes), the control unit 15 acquires the first priority assigned to the first task and the second priority assigned to the second task from the properties of the respective tasks stored in the storage unit 14. Next, the control unit 15 compares the first priority with the second priority. When it is determined that the first priority is higher than the second priority (S102—Yes), the process proceeds to S103, and when it is determined that there is no priority (S102—No), the process ends. Note that the information acquired by the control unit 15 from the properties of each task may be a type of task (for example, a task that occurs in accordance with a user operation or another task). In this case, the control unit 15 may determine the first priority assigned to the first task and the second priority assigned to the second task according to the type of the task.

The priority assigned to each task including the first priority or the second priority may be any value capable of performing a comparison, such as, for example, “high” or “low”, “0” or “1”, or an integer value. When the value used for the priority is an integer value, the priority of the smaller value may be higher, or the priority of the larger value may be higher.

In the present embodiment, the priority assigned to the task that occurs in response to the user operation is set to be higher than the priority assigned to the other tasks. However, the priority assigned to each task may be changeable.

The priority assigned to each task may be changed according to the situation of the vehicle. For example, when the state of the vehicle is before the initial setting, the priority assigned to the task for setting the vehicle may be set higher than the priority assigned to the task that occurs in response to the user operation, and when the state of the vehicle is after the initial setting, the priority assigned to the task that occurs in response to the user operation may be set higher than the priority assigned to the task for setting the vehicle.

S103: When it is determined that the first priority is higher than the second priority (S102—Yes), the control unit 15 switches the order of the first task and the second task in the queue.

Specifically, when it is determined that the first priority is higher than the second priority (S102—Yes), the control unit 15 switches the order of the first task and the second task in the queue. That is, the first task is executed before the second task. After that, the processing returns to S101.

As described above, the control unit 15 repeatedly performs the switching process (corresponding to S101 to S103 in FIG. 4) until it is determined that there is no unexecuted second task immediately before the first task in the queue (S101—No) or until it is determined that the first priority is equal to or lower than the second priority of the unexecuted second task immediately before the first task in the queue (S102—No).

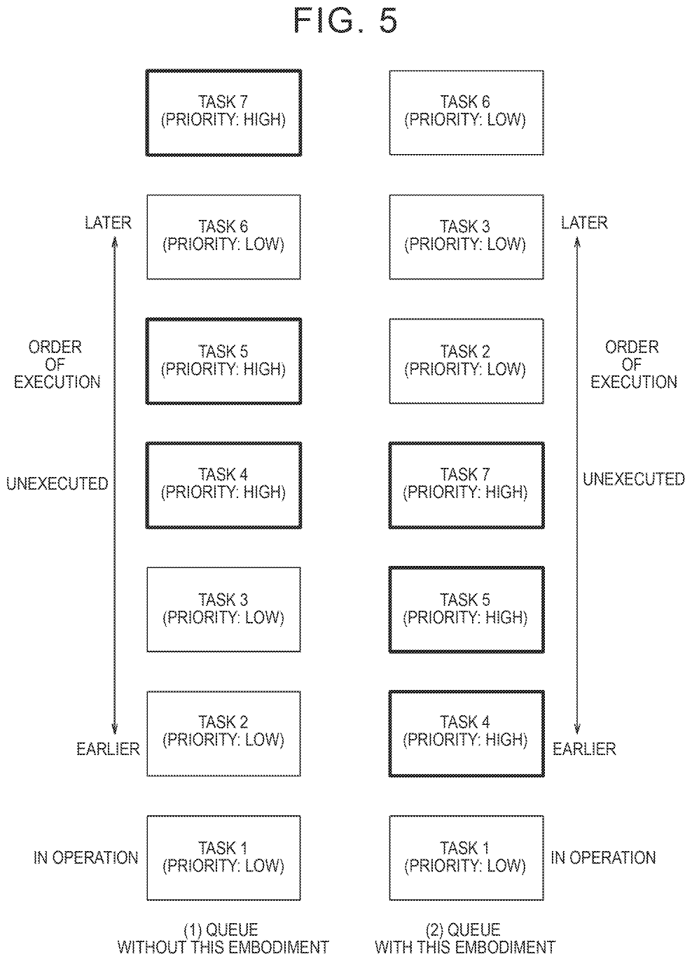

FIG. 5 shows the state of the queue of the in-vehicle device 10 in the case of not having the present embodiment and the state of the queue of the in-vehicle device 10 in the case of having the present embodiment. The number assigned to the task indicates the order of occurrence of the task. As illustrated in FIG. 5, in the queue of the in-vehicle device 10 according to the present embodiment, a task having a high priority is executed first except for the task 1 being executed.

As described above, the in-vehicle device 10 adds the first task that has occurred to the end of the queue. Next, the in-vehicle device 10 performs a switching process including a step of determining whether there is an unexecuted second task immediately before the first task in the queue, a step of comparing the first priority assigned to the first task with the second priority assigned to the second task when it is determined that the unexecuted second task, and a step of switching the order of the first task and the second task in the queue when it is determined that the first priority is higher than the second priority. The in-vehicle device 10 repeatedly performs the switching process until it is determined that there is no unexecuted second task immediately before the first task in the queue, or until it is determined that the first priority is equal to or lower than the second priority of the unexecuted second task immediately before the first task in the queue.

According to such a configuration, since the first task is executed earlier than an unexecuted task having a lower priority than the first task, the response of the function performed by the execution of the first task may be faster than that of the in-vehicle device without the present embodiment. Therefore, according to the present embodiment, the technology of the vehicle-mounted device of the next-generation vehicle is improved in that the response of the function having a high priority can be improved.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the in-vehicle device 10 does not need to be accommodated in one housing, and some of the components may be located at a distant place. For example, any combination of the communication unit 11, the output unit 12, the input unit 13, the storage unit 14, and the control unit 15 may be present at different locations in the vehicle body, or the output unit 12 and the input unit 13 may be present at the same location in the vehicle body, or may be present at other locations.

Further, for example, an embodiment in which a general-purpose computer functions as the in-vehicle device 10 according to the above-described embodiment is also possible. Specifically, a program describing processing contents for realizing each function of the in-vehicle device 10 according to the above-described embodiment is stored in a memory (storage medium) of a general-purpose computer, and the program is read and executed by a processor. Therefore, the present disclosure can also be realized as a program that can be executed by the processor or a non-transitory computer-readable medium that stores the program. The non-transitory computer-readable medium is an example of a storage medium.

What is claimed is:

1. A method that is performed by an in-vehicle device configured to add a plurality of tasks to a queue in order of occurrence, the method comprising:
adding a first task that has occurred to an end of the queue; and
performing a switching process, the switching process including the steps of
determining whether there is an unexecuted second task immediately before the first task in the queue,
when determination is made that there is the unexecuted second task, comparing a first priority assigned to the first task with a second priority assigned to the second task, and
when determination is made that the first priority is higher than the second priority, switching an order of the first task and the second task in the queue, wherein the in-vehicle device repeatedly performs the switching process until determination is made that there is no unexecuted second task immediately before the first task in the queue, or until determination is made that the first priority is equal to or lower than the second priority of the unexecuted second task immediately before the first task in the queue.

2. The method according to claim 1, further comprising setting a priority assigned to a task that occurs in response to a user operation higher than a priority assigned to a task other than the task.

3. The method according to claim 1, further comprising changing a priority assigned to each of the tasks according to a situation of a vehicle.

4. The method according to claim 3, further comprising:
when the situation of the vehicle is before initial setting, setting the priority assigned to a task for performing setting of the vehicle higher than the priority assigned to a task that occurs in response to a user operation; and
when the situation of the vehicle is after the initial setting, setting the priority assigned to the task that occurs in response to the user operation higher than the priority assigned to the task for performing setting of the vehicle.

5. A non-transitory storage medium storing a program that causes an in-vehicle device configured to add a plurality of tasks to a queue in order of occurrence to
add a first task that has occurred to an end of the queue, and
perform a switching process, the switching process including the steps of
determining whether there is an unexecuted second task immediately before the first task in the queue,
when determination is made that there is the unexecuted second task, comparing a first priority assigned to the first task with a second priority assigned to the second task, and
when determination is made that the first priority is higher than the second priority, switching an order of the first task and the second task in the queue, wherein the in-vehicle device is caused to repeatedly perform the switching process until determination is made that there is no unexecuted second task immediately before the first task in the queue, or until determination is made that the first priority is equal to or lower than the second priority of the unexecuted second task immediately before the first task in the queue.
